(19) United States
(12) Patent Application Publication
(10) Pub. No.: US 2014/0246507 A1
(43) Pub. Date: Sep. 4, 2014

(54) METHOD AND APPARATUS FOR MONIDISPERSE LIQUID PARTICLE GENERATION

(71) Applicant: UNIVERSITY OF CENTRAL FLORIDA RESEARCH FOUNDATION, INC., Orlando, FL (US)

(72) Inventors: Hongxu Duan, Oviedo, FL (US); Weiwei Yang, Orlando, FL (US); Cheng Li, Oviedo, FL (US); Weiwei Deng, Oviedo, FL (US)

(73) Assignee: UNIVERSITY OF CENTRAL FLORIDA RESEARCH FOUNDATION, INC., Orlando, FL (US)

(21) Appl. No.: 14/193,711

(22) Filed: Feb. 28, 2014

Related U.S. Application Data
(60) Provisional application No. 61/771,215, filed on Mar. 1, 2013.

(51) Int. Cl. B05B 5/025

(52) U.S. Cl. CPC B05B 5/0255
USPC 239/3; 239/690

(57) ABSTRACT

A particle generation apparatus and a particle generation method each employ: (1) a nozzle from which exits a liquid micro-jet stream; and (2) a ground electrode separated from the nozzle, where both the nozzle and the ground plane are DC voltage biased when operating the nozzle. Each of the particle generating apparatus and the particle generating method also employ a pair of AC electrodes interposed between the nozzle and the ground electrode and perpendicular to the liquid micro-jet stream. When a liquid supply is supplied to the nozzle, a DC voltage bias is supplied to the nozzle and the ground electrode, and an AC voltage bias and AC frequency bias is applied to the pair of AC electrodes a liquid particle spray is generated by the apparatus and the method. With additional parametric adjustment, the liquid particle spray may be monodisperse and bifurcated.

### CROSS-REFERENCE TO RELATED APPLICATION

This application is related to, and derives priority from, application Ser. No. 61/771,215, filed 1 Mar. 2013 and titled Method and Apparatus for Monodisperse Liquid Droplet Generation, the content of which is incorporated herein fully by reference.

### STATEMENT OF GOVERNMENT INTEREST

The research that lead to the embodiments as described herein, and the invention as claimed herein, was funded by the United States National Science Foundation under grant number CMMI 1301099 and grant number CMMI 1335295. The United States government has rights in any patent that derives from the invention as claimed herein.

### BACKGROUND

1. Field of the Invention

Embodiments relate generally to apparatus and methods for forming liquid particles (i.e., liquid droplets). More particularly, embodiments relate to apparatus and methods for independently and accurately forming monodisperse liquid particles.

2. Description of the Related Art

The breakup of liquid jets into discontinuous components (i.e., generally liquid particles, which are intended as synonymous with liquid droplets) is ubiquitous with a rich underpinning and widespread applications in various disciplines related to the physical sciences. In that regard, the natural breakup of a liquid jet into discontinuous components often originates from a small ambient perturbation, which subsequently grows, often exponentially, until an amplitude as large as a liquid jet radius is reached, which in turn facilitates fracture of the liquid jet into the related discontinuous components.

Since applications which are predicated upon the breakup of liquid jets into discontinuous components are likely to continue to develop, so also are apparatus and methods that are directed towards efficient breakup of liquid jets into discontinuous components.

### SUMMARY

The embodiments describe the phenomenology of, and provide a simplified linear model of, electrified liquid micro-jets undergoing both varicose and whipping instabilities that eventually provide discontinuous components (i.e., liquid particles or liquid droplets) of the electrified liquid micro-jets. The embodiments show that a perturbation of sweeping an electrical frequency within an electrified liquid micro-jet leads to a distinct liquid micro-jet breakup linked to a perturbation wave number and a liquid micro-jet charge level. Interestingly in accordance with the embodiments, a bifurcation mode with clean breakup appears as the two instabilities cross over at a breakup point.

Using an apparatus in accordance with the embodiments and a method in accordance with the embodiments one may realize monodisperse liquid particle generation in a liquid particle size range from about 0.5 to about 400 microns (and more preferably from about 10 to about 200 microns) with a statistical uncertainty (i.e., standard deviation) from about 1.0 to about 1.1% and generally less than about 1.2%, (more generally less than about 1.5% and still more generally less than about 2.0%).

The embodiments may be claimed in terms of either a particular liquid particle generation apparatus in accordance with the embodiments or a particular liquid particle generation method in accordance with the embodiments.

A particular liquid particle generation apparatus in accordance with the embodiments includes a nozzle from which exits a liquid stream when operating the nozzle. The apparatus also includes a DC ground plane spaced from the nozzle and with respect to which the nozzle is DC voltage biased when operating the nozzle. The apparatus also includes at least two AC electrodes positioned with respect to the liquid stream to provide an AC voltage bias and an AC frequency bias that cause the liquid stream to break into a liquid particle spray when operating the nozzle.

A particular liquid particle generation method in accordance with the embodiments includes supplying to a particle generating apparatus comprising: (1) a nozzle from which exits a liquid stream when operating the nozzle; (2) a DC ground plane spaced from the nozzle and with respect to which the nozzle is DC voltage biased when operating the nozzle; and (3) at least two AC electrodes positioned with respect to the liquid stream to provide an AC voltage bias and an AC frequency bias that cause the liquid stream to break into a liquid particle spray when operating the nozzle: (1) a liquid supply to the nozzle; (2) a DC voltage bias between the nozzle and the ground plane; and (3) an AC voltage bias and an AC frequency bias to the at least two AC electrodes, to generate the liquid particle spray when operating the nozzle.

### BRIEF DESCRIPTION OF THE DRAWINGS

The objects, features and advantages of the embodiments are understood within the context of the Detailed Description of the Non-Limiting Embodiments, as set forth below. The Detailed Description of the Non-Limiting Embodiments is understood within the context of the accompanying drawings, which form a material part of this disclosure, wherein:

FIG. 1 shows an electrified liquid micro-jet under transverse electro-hydro-dynamic (EHD) perturbation. The liquid micro-jet radius is 10 μm.

FIG. 2 shows a typical response of an electrified liquid micro-jet in accordance with the embodiments to external transverse perturbation introduced by an AC electric field between a narrow gap interposed between two coplanar blade electrodes. Vₚₚ=300 V and 2a=100 μm.

FIG. 3 shows a liquid micro-jet response phenomenon in accordance with the embodiments mapped in an x-Γ diagram. Scattered data points are experimental data.

FIG. 4 shows representative images for the x-Γ diagram under various conditions including: (a) varicose mode where, Q=16 ml/h, E_{d}=2 kV/cm, x=0.98, Γ=0.99; (b) overcharged varicose mode where, Q=16 ml/h, E_{d}=1 kV/cm, x=1.21, Γ=1.63; (c) whipping assisted bifurcation where, Q=16 ml/h, E_{d}=2.5 kV/cm, x=0.69, Γ=1.32; (d) overcharged whipping assisted bifurcation where, Q=16 ml/h, E_{d}=1.25 kV/cm, x=0.69, Γ=1.74; (e) varicose assisted bifurcation where, Q=14 ml/h, E_{d}=2.5 kV/cm, x=0.45, Γ=0.56; and (f) jet quadrufurcation as an effect of 4th harmonic of the Rayleigh frequency where, Q=2 ml/h, E_{d}=2.5 kV/cm.

### DETAILED DESCRIPTION OF THE NON-LIMITING EMBODIMENTS

The embodiments provide an understanding of liquid micro-jet breakup from the perspective of varicose phenomena and whipping phenomena within the context of liquid micro-jet breakup. By understanding these phenomena it is possible to design an electrostatically assisted liquid micro-jet nozzle and apparatus, and provide a related method, that provide for monodisperse (i.e., uniform) liquid particle size from breakup of a liquid micro-jet when operating the nozzle.

1. General Considerations for Liquid Micro-Jet Apparatus and Method

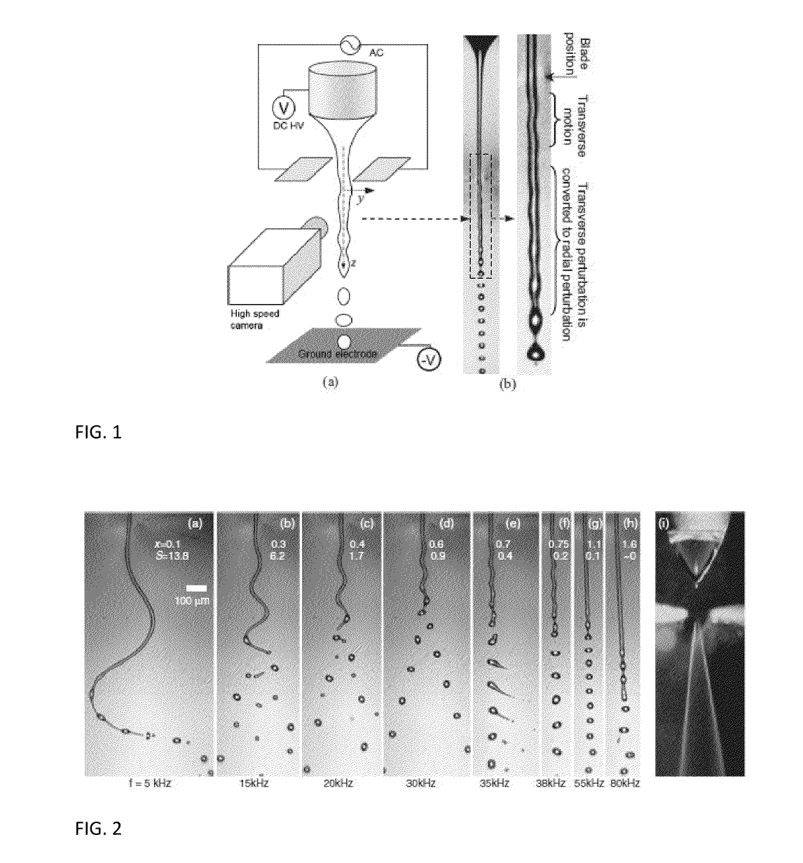

FIG. 1a shows in general a liquid micro-jet apparatus in accordance with the embodiments. The liquid micro-jet apparatus includes in particular a nozzle which is held at a DC bias voltage with respect to a ground electrode. The apparatus as illustrated in accordance with FIG. 1a also shows a pair of AC biased electrodes that is located counter-opposed and perpendicular with respect to the liquid micro-jet stream that exits the nozzle.

With respect to the nozzle of a liquid micro-jet apparatus in accordance with the embodiments, the nozzle may comprise any type of nozzle that is otherwise generally conventional, but in particular the nozzle is designed and operated in a fashion such that the nozzle will provide the liquid micro-jet having a jet radius (i.e., one half of a liquid micro-jet diameter) from about 10 to about 200 microns and more preferably from about 50 to about 100 microns. Such nozzles may otherwise include, but are not necessarily limited to syringe pump nozzles and other mechanical pump nozzles or pressure assisted nozzles. Generally, a liquid micro-jet nozzle in accordance with the embodiments may comprise a stainless steel micro tube having an inner diameter and an outer diameter selected consistent with the foregoing liquid micro-jet diameter. Typically, this will include an inner diameter from about 50 to about 200 microns and an outer diameter from about 100 to about 400 microns.

With respect to the ground electrode that is DC biased with respect to the nozzle, the ground electrode may comprise any of several electrically grounding materials which will typically and preferably include electrical conductor ground materials. Typically and preferably, the ground electrode comprises a stainless steel plate electrode or alternative non-reactive plate electrode at a thickness from about 50 to about 500 microns. Typically and preferably the nozzle is separated from the ground electrode by a separation distance from about 0.4 to about 1.8 millimeters.

Although not specifically illustrated within the schematic diagram of FIG. 1(a), the liquid particle generation apparatus in accordance with the embodiments also contemplates as an adjunct component a DC power supply having a voltage from about 500 to about 3000 volts for purposes of DC voltage biasing the nozzle with respect to the ground electrode.

With respect to the blade electrodes in accordance with the embodiments, the blade electrodes may be comprised of any of several conductor blade materials, but most particularly advanced blade electrodes may comprise conductor blade materials similar to the ground electrode. Typically and preferably, the blade electrodes are assembled with a plane of both blades perpendicular to a direction of flow of the liquid micro-jet from the nozzle with a distance from the nozzle from about 0.1 to about 1 millimeters and a distance from the ground electrode from about 0.3 to about 0.8 millimeters.

As an adjunct to the blade electrodes FIG. 1(a) shows an AC power supply that may operate at an AC voltage from about 0 to about 350 volts and a frequency from about 0 to about 500 kilohertz. It is understood by a person skilled in the art that although FIG. 1(a) illustrates the apparatus in accordance with the embodiments as including a pair of blade electrodes, blade electrodes are not necessarily a requirement for an apparatus in accordance with the embodiments. Rather the embodiment may also include electrodes including but not limited to blade electrodes, needle point electrodes and modified blade electrodes that include a cutout notch with respect to the liquid jet that in turn allows for a more uniform electric field with respect to the liquid micro-jet stream.

Finally, as is illustrated within the schematic diagram of FIG. 1(a), upon an appropriate DC electrical bias of the nozzle with respect to the ground electrode and AC voltage and frequency bias of the blade electrodes with respect to the liquid micro-jet the liquid micro-jet eventually breaks up into individual liquid droplets or liquid particles. Although as described below a particular embodiment utilized ethanol as a liquid particle generating liquid, this also is not a limitation of the embodiments. Rather, the embodiments also contemplate use of polar or non-polar solvents that may include water, alcohols and other organic solvents when generating liquid particles in accordance with the embodiments. As well, the embodiments also contemplate that a particular solvent may have a solute dissolved therein when generating a liquid particle in accordance with the embodiments, such as but not limited to oleic acid as a solute.

In accordance with the embodiments as described further below, one may generate essentially monodisperse liquid particles in a size range from about 0.5 to about 400 microns with a standard deviation generally from about 1.0 to about 1.1 percent, and more generally less than about 1.2 percent.

As is understood by a person skilled in the art, the embodiments provide a desirable advantage insofar as liquid particles may be generated of various size independent from an orifice size, which provides a cost savings when designing an apparatus in accordance with the embodiments. In comparison, for example, to generate a sub-micron liquid particle, the current liquid particle generation apparatus instrumentation options will generally use a 10 micron size orifice which gets clogged easily. When it comes to solid particles like sodium chloride, it is infeasible to use even a 20 micron orifice in practice.

Moreover, as is seen in particular within FIG. 2, and as will be discussed in further detail below, not all experimental configurations and operating parameters of an apparatus in accordance with the embodiments or a method in accordance with the embodiments will necessarily provide a monodisperse liquid particle spray. Rather, with particular consideration of FIG. 2 whipping instability as illustrated in FIG. 2(a), FIG. 2(b) and FIG. 2(c) provides a population of smaller sized satellite particles in addition to a population of larger sized primary particles when a liquid micro-jet disintegrates into a liquid particle spray. In addition a varicose instability as illustrated in FIG. 2(e) and FIG. 2(h) also provides a population of smaller sized satellite particles in addition to a population of larger sized primary particles when a liquid micro-jet disintegrates into a liquid particle spray. However, under certain cross-over conditions between whipping instability and varicose instability as illustrated in FIG, 2(d), as well as within a subset of varicose instability conditions as illustrated in FIG. 2(f) and FIG. 2(g), an essentially monodisperse liquid particle spray is obtained from a liquid micro-jet, in accordance with the statistical limitations of a monodisperse liquid particle stream as described above.

Within the context of FIG. 2(d), FIG. 2(f) and FIG. 2(g), FIG. 2(d) is particularly interesting insofar as the primary liquid micro-jet stream upon both whipping and varicose instability breaks into two divergent monodisperse liquid particle streams.

In light of the foregoing observations with respect to FIG. 2, one may reasonably assume that additional sets of values for liquid flow, DC bias voltage, AC bias voltage and AC frequency will also provide additional monodisperse liquid particle populations within liquid particle streams at different liquid particle sizes. Discerning particular operational conditions that effect that result is not regarded as involving undue experimentation insofar as the number and ranges of experimentally controllable variables is limited.

Thus, within the context of a method in accordance with the embodiments one may within a first process step supply a liquid to a nozzle within an apparatus in accordance with the embodiments to provide a liquid micro-jet. One may then provide the DC bias voltage, the AC bias voltage and the AC bias frequency, with adjustment of the foregoing voltages and frequency until a point is reached that provides a monodisperse particle spray from the liquid micro-jet.

2. Experimental Considerations

2.1 Experimental Apparatus Configuration in Accord With Embodiments

FIG. 1(a) shows a schematic diagram of an experimental apparatus configuration in accordance with the embodiments. To generate an electrified micro-jets while using the experimental apparatus configuration whose schematic diagram is illustrated in FIG. 1(a), a liquid is fed through a stainless steel capillary (OD=300 μm and ID=150 μm) charged at ˜2 kV. Under an intense dc electric field, a liquid meniscus deforms into a Taylor cone, with a jet erupting from the tip of the Taylor cone. The liquid used in the experiments that comprise the embodiments was pure ethanol. The liquid micro-jet diameter was controlled by varying the liquid flow rate from 1 ml/h to 16 ml/h, corresponding with a liquid micro-jet diameter from about 10 to 50 μm.

A transverse perturbation was introduced by the fringe electric field in a small gap (˜200 μm) interposed between two razor blades located on the same flat plane. Each blade was mounted on an x-y-z stage for precise gap adjustment and position alignment. The two blades, modeled as thin plates, are connected to a sinusoidal alternating current (AC) power signal source. Within the context of the embodiments, it is preferred to use thin blade electrode plates instead of cylindrical rods or wires insofar as the thin blade electrode plates essentially form an “extractor” electrode, allowing an intense DC component of the electric field to be established between the nozzle and the blades. At 15 mm below the blade electrodes is a collector electrode charged at voltage of −1 kV to −4 kV. The collector electrode has the dual function of sweeping the charged droplets away from the blade electrode and adjusting the jet charge level as discussed in further detail below. The AC signal has Vₚₚ (peak-to-peak voltage) from 0 to 330 V with zero DC offset, and the virtual ground is the same as the DC power supplies. The horizontal electric field E (z, t) at the symmetric plane of two large and thin plates can be solved using conformal mapping and the solution is:

E(z, t)=E₀(z)sin 2π f t,

E₀(z)=2Vₚₚ/[πα\sqrt{1+(z/α)²}], (1)

where 2a is the gap, and z=0 corresponds to the position of the blade plane.

The AC frequency applied is from 10 to 200 kHz. The natural oscillation frequency of a liquid meniscus (Taylor cone in this case) can be estimated by [γ/ρRₙ³]^{1/2}, where γ is the liquid-air interfacial tension, ρ is the liquid mass density and Rₙ is the nozzle radius. For a typical nozzle diameter of 300 μm, the Taylor cone oscillation frequency is below 1 kHz, which is much less than the frequency range of the AC signal applied. Therefore, despite the fact that the blade electrodes are close to the nozzle, the experimental configuration as illustrated in FIG. 1(a) can generate stable and reproducible electrified liquid micro-jets insofar as the Taylor cone does not respond to the relatively high frequency ac signal.

The liquid micro-jet has surface charge density of σ=I/(2πRvⱼ), where I is current carried by the jet, R is the unperturbed jet radius and vⱼ is the jet velocity. The dimensionless charge level Γ is defined as the ratio of electric stress to surface tension of the jet, i.e., Γ=σ²R=ε₀γ, with ε₀ being vacuum permittivity. Experimentally, Γ can be varied in two ways: either by changing the flow rate, or by changing the jet velocity. Note that σ is independent of the flow rate Q, while R scales with Q^{α}, where α is a scaling factor typically between ⅓ and ½. This suggests the charge level Γ ∝Q_{α}. On the other hand, if Q is fixed, one can find that Γ ∝vⱼ^{-2-α}, and the jet velocity vⱼ can be tuned by adjusting the driving field between the blades and the collector.

The experimental phenomena were recorded with a high speed camera (Phantom v12.1) and a long working distance microscope lens. A collimated LED light source was placed behind the jet and pointed to the camera to form the shadowgraph configuration.

2.2 Experimental Results and Discussion

FIG. 2 shows a typical experimental phenomena of electrified micro-jets under transverse electrohydrodynamic (EHD) excitation at different wave number x=2πRf/vⱼ. The image sequence as illustrated in FIG. 2 suggests that the whipping dominates at small wave numbers while varicose is more prominent for larger wave numbers.

One may gain substantial insights from a simplified linear model without undertaking the complex nonlinear description of the problem. One may first write a dispersion relationship for a charged jet:

$${ω}_{m}^{2} = {ω}_{R}^{2} x \frac{{I}_{m}^{′} ( x )}{{I}_{m} ( x )} [ ( 1 - {m}^{2} - {x}^{2} ) - Γ ( 1 + x \frac{{K}_{m}^{′} ( x )}{{K}_{m} ( x )} ) ] , \qquad ( 2 )$$

where ωₘ is the instability growth rate at wave number x, ω_{R}=(γ/ρR³)^{1/2}, Iₘ(x), and Kₘ(x) are modified Bessel functions of the first and second kind.

The phenomenology is consistent with the dispersion relationship of Eq. (2), where the varicose growth rate is greater than the whipping growth rate for small x and the trend is reversed for large x. However, the growth rate alone does not provide the complete picture. The phenomenology should be determined by the combined effect of both growth rate and the initial perturbation. To that end, one may next estimate the magnitude of initial transverse and radial perturbations. One may use the azimuthal number m to denote the perturbation mode, with m=0, 1 being the axisymmetric (varicose) and transverse (whipping) perturbations, respectively. As the micro-jet passes the blade electrodes, the horizontal stress acting on the micro-jet is E (z; t) σ, and the micro-jet will bend transversely with initial magnitude of δy during the first half cycle 1//(2f). The bending motion of the micro-jet can be numerically solved if one only considers inertia and assumes internal flows are negligible for small perturbations. These assumptions are proved to be reasonable, as decent agreement between δy obtained numerically and experimentally. Moreover, at sufficiently high frequency, within a half cycle ½f, the micro-jet only travels a short distance compared to a, i.e., f>vⱼ/2a. Then, E (z; t)∞E (z=0; t), which suggests that the dimensionless initial whipping perturbation is ξ₁=δy/λ=CVₚₚ/(af), where C is a geometric correction factor of order 10⁻⁴ for the experimental setup in this work.

The radial perturbation can be estimated using mass conservation πR²ds+2πRsdR=0, where s is the stretched micro-jet length over half wavelength λ/2, and dR can be interpreted as the radial perturbation. For sinusoidal curves with small magnitude, ds≈δy²/2λ, and the dimensionless varicose perturbation is ξ₀=dR/R=(δy/λ)²/4=ξ₁²/4.

At this point one may write ηm, the dimensionless radial m=0 or transverse (m=1) perturbation as ηm(t)=ξₘ exp(ωwₘt). Then the relative importance of the two instabilities can be quantified by the crossover ratio:

S=[ληₜ(t)]/[Rη₀(t)], (3)

Of particular interest of this ratio is the breakup point, at which the dimensionless radial perturbation grows into unity or η₀ (t_{B})=1, where t_{B} is the time elapsed between the breakup point and the liquid mass first passes the EHD exciter. t_{B} is estimated by choosing the smaller value between excited breakup time t₀=−ln(ξ₀)/ω₀ and natural breakup time t_{R≈}35=ω_{R} (if the natural perturbation outgrows exited perturbation). Therefore, at the breakup point, the crossover ratio becomes:

S=λη₁(t_{B})/R, (4)

The S value indicates the relative importance of the whipping and varicose instabilities. Experimentally, λ can be obtained from the jet velocity and excitation frequency, while η₁ can be directly measured from images. One may emphasize that because Eq. (4) is essentially based on a linear model, for small wave numbers the crossover ratio should be considered only qualitative.

In FIG. 2(a) (x=0.1), S=13.8>>1, indicating the whipping should dominate. Indeed, FIG. 2(a) clearly shows that whipping mode dictates the shape of the micro-jet. The varicose mode appears to be superimposed on the whipping mode. As the wave number increases as illustrated in FIG. 2(b) and FIG. 2(c), the micro-jet still exhibits primarily the whipping mode because S remains greater than unity. However, varicose mode plays an increasingly important role, leading to earlier micro-jet breakup. Interestingly, near certain wave numbers, the crossover ratio S is close to 1, see FIG. 2(d), and the importance of whipping and varicose modes is comparable, resulting in a unique whipping assisted bifurcation mode. The liquid micro-jet breaks up into two identical droplets within each excitation period without any satellite droplets. This phenomenon happens when the whipping mode has nonzero growth rate, and the 2nd harmonic of the applied perturbation is close to the Rayleigh frequency which has the maximum growth rate. When bifurcation is observed with the naked eye, the jet appears to split into two as illustrated in FIG. 2(i).

As the wavelength is further reduced, S becomes less than 1, whipping is suppressed, and the varicose instability dominates as is illustrated in FIG. 2(e) to FIG. 2(g). Noticeably, in FIG. 2(e), the jet breaks up within each complete excitation period (instead of the half excitation period in the bifurcation mode) into dumb bell shaped liquid segments. When the liquid segment tries to regain spherical shape, the reduced surface area gives rise to surface charge density that exceeds the Rayleigh charge limit, in which electric stress overwhelms the surface tension. Consequently, the newly formed droplet would experience Coulombic fission, shedding smaller droplets to reduce the charge level of the main droplet below the Rayleigh limit, as illustrated in FIG. 2(e).

In FIG. 2(g), the small value of S suggests that whipping instability virtually does not develop. The jet breakup is almost entirely governed by the varicose mode. At even higher wave number as illustrated in FIG. 2(h), the applied EHD excitation does not contribute to varicose instability, and the jet behaves similarly as a natural, unperturbed jet.

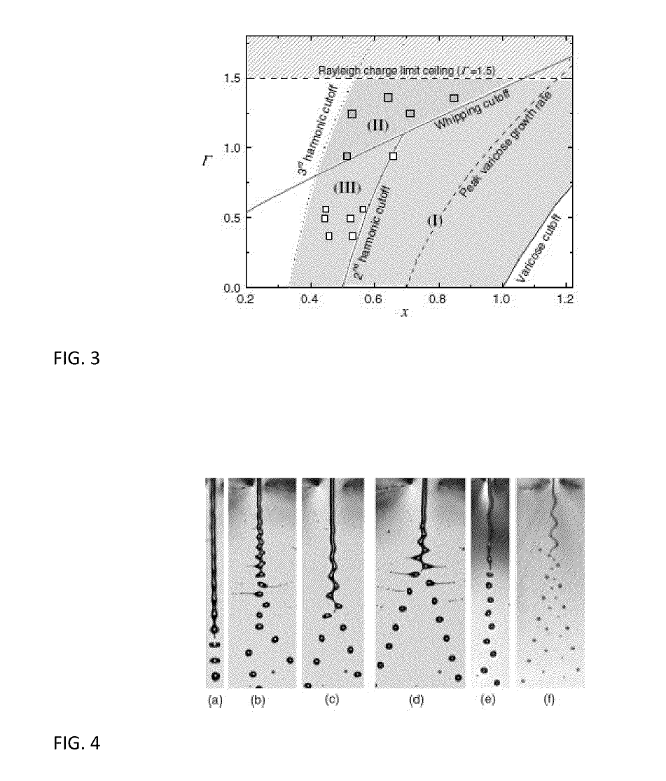

One may further map the phenomenology in the x-Γ diagram as illustrated in FIG. 3 to take both charge levels and wave numbers into account. The distinct modes of micro-jet response behavior are separated by boundaries set by the Rayleigh limit ceiling Γ≦1.5 and several cutoff curves obtained from the dispersion relationship. Here the “cutoff”: refers to the zero growth rate of the corresponding instability, and below the cutoff curve, the corresponding instability will not grow. Specifically, these modes of micro-jet response are:

2.2.1 (i) The varicose or Rayleigh mode.—[zone I and FIG. 4(a)] which is at the proximity of the maximum growth rate of the varicose mode (dashed curve).

Stronger perturbation (i.e., larger Vₚₚ/a) will expand the area of the domains of the varicose mode. In principle, the domain is bound by the 2nd harmonic cutoff, whipping cutoff, and varicose cutoff curves. A submode can be identified as the overcharged varicose mode FIG. 4(b), which is above the Rayleigh limit ceiling, and generated droplets experience Coulombic fission.

2.2.2. (ii) The whipping assisted bifurcation mode.—[zone II and FIG. 4(c)], which is bound by the 3rd harmonic and whipping cutoff curves.

In this domain, the whipping has nonzero growth rate and tears the micro-jet in an alternating fashion that assists jet bifurcation. Again, above the Rayleigh limit ceiling, the generated droplets experience Coulombic fission as seen in FIG. 4(d). In addition, stronger perturbation also will push the data points closer to the boundary of cutoff curves.

2.2.3 (iii) The varicose assisted bifurcation mode.—[zone III and FIG. 4(e)], which is bound by cutoff curves of the 2nd harmonics, 3rd harmonics, and whipping instabilities.

In this mode, the micro-jet charge levels are low and the jet wavy patterns from initial transverse perturbation will not be amplified because of the zero growth rate of whipping. It is the varicose instability that drives the wavy jet breakup. Bifurcation happens because the formed droplets are off from the center line alternatingly due to the initial wavy micro-jet pattern. One may note that jet bifurcation similar to the behavior in zone (iii) has been reported. The liquid micro-jet is charge neutral (Γ=0), and the perturbation was introduced through the transverse vibration of a slender glass nozzle. Despite the different source of perturbation, the micro-jet breakup behavior can still be categorized as varicose assisted bifurcation which falls into zone (iii) of the x-Γ diagram.

At smaller wave numbers, phenomena corresponding to higher order harmonics of the Rayleigh mode can be identified. For example, FIG. 4(f) shows one such case. The jet appears to experience quadrufurcation, emitting four streams of droplets. It can be linked to the 4th harmonic of the Rayleigh mode. Here, during each complete transverse motion cycle, the 4th harmonic of the radial perturbation has a nonzero growth rate that breaks up the cycle into four droplets.

In summary, observed and categorized are different outcomes of breakup of electrified jets that undergo both varicose and whipping instabilities. The codevelopment of transverse and axisymmetric perturbations leads to remarkable jet breakup behavior attributable to initial perturbation magnitude, perturbation wave numbers, and jet surface charge levels. The experiment apparatus used in this work provides a simple and nonintrusive approach to systematically induce the whipping instability of the electrified micro-jets. The well-controlled triggering and codevelopment of the instabilities expands the possibilities of electrified jets breakup, and may spawn new ways of generating micro- or nanodroplets and controlled electro spinning.

All references, including publications, patent applications, and patents cited herein are hereby incorporated by reference in their entireties to the extent allowed, and as if each reference was individually and specifically indicated to be incorporated by reference and was set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein is merely intended to serve as a shorthand method of referring individually to each separate value falling within the range, unless otherwise indicated herein, and each separate value is incorporated into the specification as if it was individually recited herein.

All methods described herein may be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A liquid particle generation apparatus comprising:
a nozzle from which exits a liquid stream when operating the nozzle;
a DC ground plane spaced from the nozzle and with respect to which the nozzle is DC voltage biased when operating the nozzle; and
at least two AC electrodes positioned with respect to the liquid stream to provide an AC voltage bias and an AC frequency bias that cause the liquid stream to break into a liquid particle spray when operating the nozzle.

2. The apparatus of claim 1 wherein the liquid stream has a radius from about 10 to about 200 microns.

3. The apparatus of claim 1 wherein the DC ground plane is spaced from the nozzle by a distance from about 0.4 to about 1.8 millimeters.

4. The apparatus of claim 1 wherein the nozzle and the DC ground plane are adapted to accept a DC voltage bias from about 500 to about 3000 volts with respect to each other.

5. The apparatus of claim 1 wherein the at least two AC electrodes are interposed between the nozzle and the ground plane.

6. The apparatus of claim 1 wherein the at least two AC electrodes comprise coplanar flat blade shaped AC electrodes.

7. The apparatus of claim 1 wherein the at least two AC electrodes comprise pointed needle shaped AC electrodes.

8. The apparatus of claim 1 wherein the at least two AC electrodes comprise notch modified coplanar flat blade shaped AC electrodes.

9. The apparatus of claim 1 further comprising a DC power supply adapted for DC voltage biasing the nozzle with respect to the ground plane.

10. The apparatus of claim 9 wherein the DC power supply has a DC voltage from about 500 to about 3000 volts.

11. The apparatus of claim 1 further comprising an AC power supply adapted for AC voltage biasing and AC frequency biasing the at least two AC electrodes with respect to the liquid stream.

12. The apparatus of claim 11 wherein the AC power supply has an AC voltage from about 0 to about 300 volts and an AC frequency from about 0 to about 500 kilohertz.’

13. A particle generating method comprising:
supplying to a particle generating apparatus comprising:
a nozzle from which exits a liquid stream when operating the nozzle;
a DC ground plane spaced from the nozzle and with respect to which the nozzle is DC voltage biased when operating the nozzle; and
at least two AC electrodes positioned with respect to the liquid stream to provide an AC voltage bias and an AC frequency bias that cause the liquid stream to break into a liquid particle spray when operating the nozzle, a liquid supply to the nozzle, a DC voltage bias between the nozzle and the ground plane and an AC voltage bias and an AC frequency bias to the at least two AC electrodes to generate the liquid particle spray when operating the nozzle.

14. The particle generating method of claim 13 wherein the liquid stream has a radius from about 10 to about 200 microns.

15. The particle generating method of claim 13 wherein the at least two AC electrodes comprise coplanar blade electrodes.

16. The particle generating method of claim 13 wherein:
the DC voltage bias is from about 500 to about 3000 volts;
the AC voltage bias is from about 0 to about 350 volts; and
the AC frequency bias is from about 0 to about 500 kilohertz.

17. The particle generating method of claim 13 wherein:
the supplying the liquid is provided as a first step; and
the providing the DC voltage bias and the providing the AC voltage bias and the providing the DC frequency bias is provided as a second step, where the DC voltage bias and the AC voltage bias and the AC frequency bias are selected to provide a monodisperse liquid particle spray from the liquid stream.

18. The particle generation method of claim 17 wherein the monodisperse liquid particle spray has a monodisperse liquid particle size from about 0.5 to about 400 microns.

19. The particle generation method of claim 18 wherein the monodisperse liquid particle size has a standard deviation less than about 1.2 percent.

20. The particle generation method of claim 13 wherein the monodisperse liquid particle spray is bifurcated.
